(19) United States
(12) Patent Application Publication
(10) Pub. No.: US 2004/0145669 A1
(43) Pub. Date: Jul. 29, 2004

(54) Viewfinder for a video camera

(76) Inventor: Ben Van Den Herik, Oosterhout (NL)

Correspondence Address: Joseph S Tripoli, Thomson Licensing Inc, Patent Operations CN 5312, Princeton, NJ, 08543-0028, US

(21) Appl. No.: 10/475,205

(22) PCT Filed: Apr. 17, 2002
(86) PCT No.: PCT/EP02/04240

(30) Foreign Application Priority Data
Apr. 19, 2001 (DE) 101 19 378.5

(51) Int. Cl. H04N 5/222

(52) U.S. Cl. 348/333.01

(57) ABSTRACT

The inventions relates to a viewfinder for a video camera having a cathode ray tube to find the optimal focus position of the viewfinder picture. The cathode ray tube has a deflection system for deflection of the electron beam. The viewfinder is equipped with two different operating modes in which the picture of the viewfinder in the second operating mode with regard to the picture in the first operating mode is enlarged. The size is reached in that way that the horizontal flyback time of the second operating mode with regard to the flyback of the first operating mode will be enlarged in such a way that the flyback of the second operating mode will start earlier and stop later.

The invention relates to a viewfinder for a camera, notably to a viewfinder allowing magnifying of the displayed picture. The viewfinder display is a cathode ray tube (CRT).

Even with high resolution HDTV viewfinders, it is often difficult in practice to find the optimal focus position with a relatively small viewfinder. The size of details in the displayed picture is so small that the eye is unable to discern them in normal conditions. This problem can be solved partly by approximatively doubling the screen size of the viewfinder compared to standard viewfinders. This would however lead to bulky viewfinders with high energy consumption. The camera unit “LDK 9000” was provided with focussing assistant means called “Magnifier”. By triggering shortly this function, the central part of viewfinder picture is enlarged to whole viewfinder screen. The picture is enlarged about 1.6 times, thus providing a viewfinder picture where the perception of horizontal and vertical details is improved. This solution is described in German patent application DE 40 18 492 A1.

The solution described in the cited patent application was implemented in a viewfinder with variable capacitance of the S-correction of the horizontal deflection circuit, which led to a somewhat non-linearity in the picture enlargement. This embodiment is also described in DE 40 18 492.

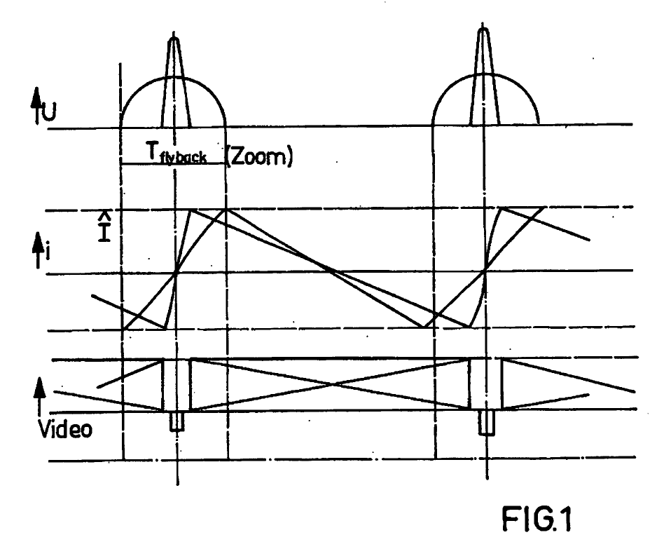

The present invention proposes another way to enlarge the central part of the picture, according to which the flyback period is increased and the horizontal deflection current keeps the same peak value, as shown on FIG. 1.

The horizontal line deflection starts with a delay due to the then-longer flyback period and ends in advance due to the late start of the flyback. Consequently, only a part of the video information is displayed on the viewfinder screen. As the flyback period is increased symmetrically, the video information is enlarged from the middle of the viewfinder screen. In most deflection processors, the phase comparator generally detects the middle of the horizontal synchronisation pulse and the middle of the horizontal flyback. Other systems, which do not use this type of phase comparator, need an additional circuit to correct the horizontal phase value. The amplitude of the vertical deflection is similarly enlarged, in order to keep an aspect ratio of about 16:9.

An advantage of the present invention over the prior art is that the linearity of the viewfinder picture is improved and that the center of the picture is not displaced when the “Picture-enlargement”-function is activated.

1. Viewfinder for a video camera having a cathode ray tube to display the viewfinder image, wherein the cathode ray tube has a deflection system for deflection of the electron beam, characterised in that said viewfinder has two different operating modes and in that the horizontal flyback time of the second operating mode is enlarged with regard to the flyback time of the first operating mode in such a way that the flyback of the second operating mode starts earlier and stops later.

2. Viewfinder according to claim 1, characterised in that the horizontal flyback is symmetrical to the horizontal synchronisation pulse in the second operating mode.

3. Viewfinder according to claim 1, characterised in that the amplitude of the vertical deflection current is increased in the second operating mode in such a way that the aspect ratio of the picture in the viewfinder is substantially the same in both operating modes.
